(19) United States
(12) Patent Application Publication
(10) Pub. No.: US 2022/0232487 A1
(43) Pub. Date: Jul. 21, 2022

(54) ENHANCED POWER CONTROL FOR HIGH PRIORITY (HP) AND LOW PRIORITY (LP) UPLINK (UL) TRANSMISSION MULTIPLEXING

(71) Applicant: QUALCOMM Incorporated, San Diego, CA (US)

(72) Inventors: Wei YANG, San Diego, CA (US); Yi HUANG, San Diego, CA (US); Peter GAAL, San Diego, CA (US)

(21) Appl. No.: 17/647,927

(22) Filed: Jan. 13, 2022

Related U.S. Application Data
(60) Provisional application No. 63/138,040, filed on Jan. 15, 2021.

(51) Int. Cl. H04W 52/32; H04W 52/10

(52) U.S. Cl. CPC H04W 52/325; H04W 52/10

(57) ABSTRACT

Certain aspects of the present disclosure provide a method of wireless communications, including: multiplexing a first uplink control information (UCI) and a second UCI on a physical uplink control channel (PUCCH), wherein the first UCI has a first priority and the second UCI has a second priority, wherein the first priority is higher in priority than the second priority, computing a transmit power based on one or more power control parameters associated with the first UCI, and transmitting the PUCCH in accordance with the transmit power.

### CROSS-REFERENCE TO RELATED APPLICATION(S)

This application claims benefit of and priority to U.S. Provisional Application No. 63/138,040, filed Jan. 15, 2021 which is hereby assigned to the assignee hereof and hereby expressly incorporated by reference herein in its entirety as if fully set forth below and for all applicable purposes.

### INTRODUCTION

Aspects of the present disclosure relate to wireless communications, and more particularly, to techniques for enhanced power control for high priority (HP) and low priority (LP) uplink (UL) transmission multiplexing.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method of wireless communications, comprising: multiplexing a first uplink control information (UCI) and a second UCI on a physical uplink control channel (PUCCH), wherein the first UCI has a first priority and the second UCI has a second priority; computing a transmit power for transmitting the PUCCH based on a first set of one or more power control parameters associated with the first UCI and a second set of one or more power control parameters associated with the second UCI; and transmitting the PUCCH in accordance with the transmit power.

Another aspect provides a method of wireless communications, comprising: multiplexing a first UCI and a second UCI on a PUCCH, wherein the first UCI has a first priority and the second UCI has a second priority; computing a transmit power based on a total number of bits of the first and second UCI multiplexed in the PUCCH; and transmitting the PUCCH in accordance with the transmit power

Another aspect provides a method of wireless communications, comprising: multiplexing a first UCI and a second UCI on a PUCCH, wherein the first UCI has a first priority and the second UCI has a second priority, wherein the first priority is higher than the second priority; computing a transmit power based on one or more power control parameters associated with the first UCI; and transmitting the PUCCH in accordance with the transmit power.

Other aspects provide: an apparatus operable, configured, or otherwise adapted to perform the aforementioned one or more methods as well as those described elsewhere herein; non-transitory, computer-readable media comprising instructions that, when executed by one or more processors of a processing system, cause the processing system to perform the aforementioned one or more methods as well as those described elsewhere herein; a computer program product embodied on a computer readable storage medium comprising code for performing the aforementioned one or more methods as well as those described elsewhere herein; and an apparatus comprising means for performing the aforementioned one or more methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE FIGURES

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station (BS) and an example user equipment (UE).

FIGS. 3A-3D depict various example aspects of data structures for a wireless communication network.

FIG. 4 is a flow diagram depicting an example method for enhanced power control by a UE.

FIG. 5 depicts an example data flow between a UE and a BS for power control when transmitting a physical uplink control channel (PUCCH) with a multiplexed payload.

FIG. 6 depicts an example data flow between a UE and a BS for power control, when transmitting a PUCCH with a multiplexed payload, using a common open loop power control parameter.

FIG. 7 depicts an example data flow between a UE and a BS for power control, when transmitting a PUCCH with a multiplexed payload, using different open loop power control parameters.

FIG. 8 depicts an example data flow between a UE and a BS for power control, when transmitting a PUCCH with a multiplexed payload, based on an effective coding rate based on a total number of uplink control information (UCI) bits.

FIG. 9 is a flow diagram depicting an example method for enhanced power control by a UE.

FIG. 10 is a flow diagram depicting an example method for enhanced power control by a UE.

FIG. 11 depicts aspects of an example communications device.

### DETAILED DESCRIPTION

5G wireless communication networks may support various advanced wireless communication services, such as enhanced mobile broadband (eMBB), millimeter wave (mmW), machine type communications (MTC), and/or mission critical targeting ultra-reliable, low-latency communications (URLLC). Such services typically have different priorities with different latency and reliability requirements. For example, URLLC traffic typically has higher priority than eMBB traffic.

Occasionally, both high priority (HP) and low priority (LP) traffic may be scheduled to be sent on the same time and frequency resources, resulting in a condition referred to as a collision. For example, HP uplink control information (UCI) and LP UCI may be scheduled on colliding physical uplink control channel (PUCCH) or physical uplink shared channel (PUSCH) resources.

In some systems (e.g., NR 3GPP Release 16), when HP and LP UCI collide, the LP uplink (UL) transmission may simply be dropped. In other systems (e.g., NR 3GPP Release 17), however, the HP UCI and LP UCI may be multiplexed in a common PUCCH. The transmit power of a PUCCH transmission depends on the effective coding rate of the transmission. Thus, this presents a challenge when multiplexing HP and LP UCI, given the HP UCI and LP UCI may be separately encoded, resulting in different coding rates.

Aspects of the present disclosure, however, provide various techniques for determining the transmit power when HP UCI and LP UCI are multiplexed in a PUCCH transmission. As a result, transmit power may be flexibly controlled, which may help ensure successful delivery of higher priority control information, while still delivering lower priority control information, when possible. This may also help avoid needlessly dropping control information, while still avoiding increasing transmit power unnecessarily.

### Introduction to Wireless Communication Networks

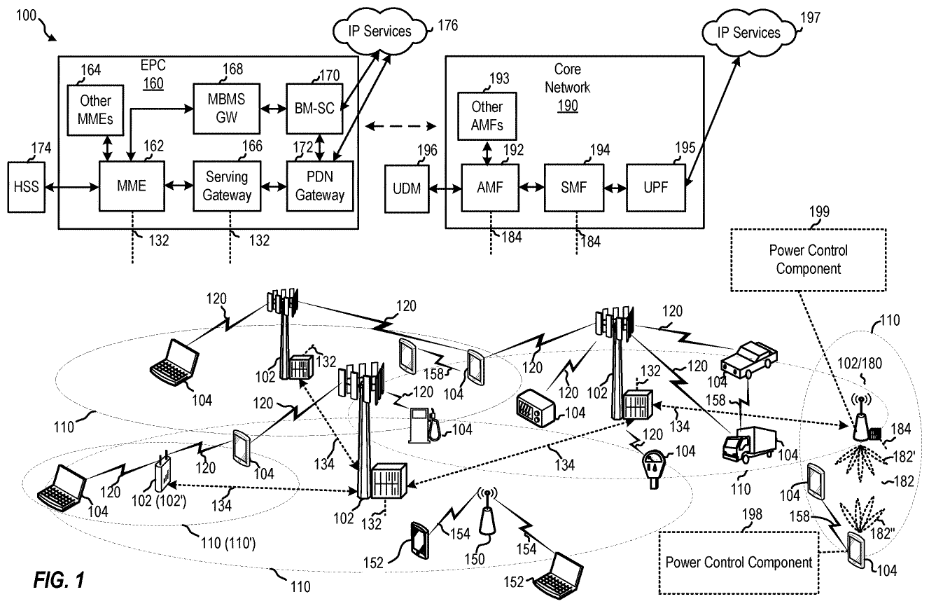

FIG. 1 depicts an example of a wireless communication network 100, in which aspects described herein may be implemented.

Generally, wireless communication network 100 includes base stations (BSs) 102, user equipments (UEs) 104, an Evolved Packet Core (EPC) 160, and core network 190 (e.g., a 5G Core (5GC)), which interoperate to provide wireless communications services.

BSs 102 may provide an access point to the EPC 160 and/or core network 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. BSs 102 may include and/or be referred to as a gNB, Node B, eNB, an access point (AP), a base transceiver station, a radio base station, a radio transceiver, or a transceiver function, or a transmit reception point (TRP) in various contexts.

BSs 102 wirelessly communicate with UEs 104 via communications links 120. Each of BSs 102 may provide communication coverage for a respective geographic coverage area 110, which may overlap in some cases. For example, small cell 102′ (e.g., a low-power BS) may have a coverage area 110′ that overlaps the coverage area 110 of one or more macrocells (e.g., high-power BS).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Wireless communication network 100 includes power control component 199, which may be used to configure one or more sets of power control parameters between BSs 102 and UEs 104. Wireless network 100 further includes power control component 198, which may be used by UEs 104 to compute the transmit power for transmitting a physical uplink control channel (PUCCH) with a multiplexed payload.

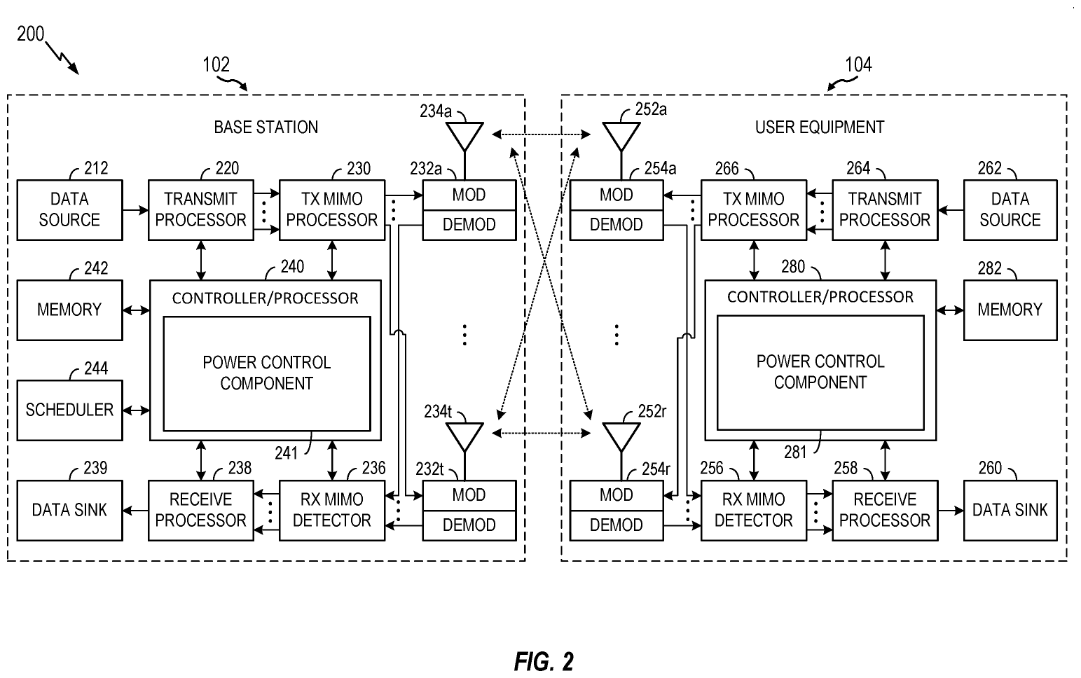

FIG. 2 depicts aspects of an example BS 102 and an example UE 104.

Generally, BS 102 includes various processors (e.g., 220, 230, 238, and 240), antennas 234a-t, transceivers 232a-t, and other aspects, which are involved in transmission of data (e.g., source data 212) and reception of data (e.g., data sink 239). For example, BS 102 may send and receive data between itself and UE 104. BS 102 includes controller/processor 240, which comprises power control component 241. Power control component 241 may be configured to implement BS 102 power control component 199 of FIG. 1.

Generally, UE 104 includes various processors (e.g., 258, 264, 266, and 280), antennas 252a-r, transceivers 254a-r, and other aspects, involved in transmission of data (e.g., source data 262) and reception of data (e.g., data sink 260). UE 104 includes controller/processor 280, which comprises power control component 281. Power control component 281 may be configured to implement UE 104 power control component 198 of FIG. 1.

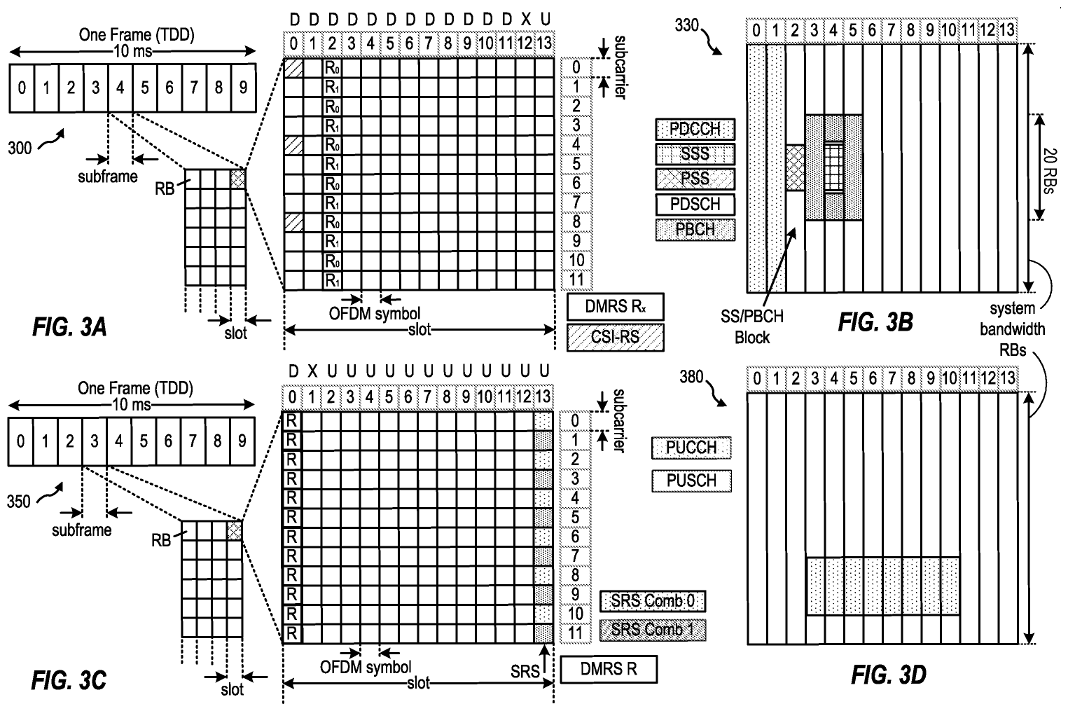

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Enhanced Power Control for High Priority (HP) and Low Priority (LP) Uplink (UL) Transmission Multiplexing

As mentioned above, typical usage scenarios for 5G may include enhanced Mobile Broad Band (eMBB), massive Machine Type Communications (mMTC), which realizes large numbers of simultaneous connections, and Ultra-Reliable and Low-Latency Communications (URLLC). These services, and others, may include latency and reliability requirements.

End-to-end (E2E) latency requirements may be concerned with over-the-air (OTA) transmission delay, queuing delay, processing/computing delay and retransmissions, when needed, while reliability requirements may be concerned with the capability of transmitting a given amount of traffic within a predetermined time duration with high success probability.

In New Radio (NR), 3rd Generation Partnership Project (3GPP) Release 16, downlink (DL) preemption, which already existed in 3GPP Release 15, was extended to include uplink (UL) transmissions. More specifically, Release 16 defines two priority levels in the UL to serve traffics with different latency and reliability requirements, such as eMBB and URLLC. For example, a low priority (LP) may be defined for eMBB communications while a high priority (HP) may be defined for URLLC.

Scheduling approaches in 3GPP Release 16 focus on such priority-based transmissions to define UL traffic rules. As noted above, in a case where transmissions of at least two UL transmissions are in conflict, the UL transmission with the lower priority may be preempted. For example, LP UL transmission(s) (e.g., physical uplink control channel (PUCCH)/physical uplink shared channel (PUSCH) may be dropped when colliding with HP UL transmission(s) in a same PUCCH group.

Uplink control information (UCI) messages may include, for example, hybrid automatic repeat request acknowledgement (HARQ-ACK) feedback, channel state information (CSI), and a scheduling request (SR). These message maybe encoded and transmitted via a PUCCH. UCI may be HP or LP, and in some cases HP and LP UCI may be multiplexed in a PUCCH. NR 3GPP Release 17 defines when a UE may need to multiplex both a LP UCI and a HP UCI in a PUCCH.

Transmit power of a PUCCH transmission is computed by the UE prior to transmission of the PUCCH. In wireless systems, one of the main challenges may include adapting the transmitting signal to overcome the variations of the wireless channel. Power control may be used to limit the interference level. Thus, UL power control generally refers to the ability of a transmitter UE to sets its output power in accordance with channel quality. For example, transmit power may be increased to meet required a signal-to-noise ratio (SNR) or a bit error rate (BER) at a wireless node (e.g., BS), while transmit power may be decreased to minimize co-channel interference of the 5G system. Two types of power controls may include open loop power control and closed loop power control.

NR defines a power control equation for the transmit power (P_{PUCCH}) from a UE for a PUCCH:

P_{PUCCH}=min{P_{c,max}, P₀(j)+PL(q)+10log₁₀(2^{μ}M_{RB})+Δ_{F}+Δ_{TF}+g(ι)}

where P_{c,max} is the maximum transmit power, P₀(j) is an open loop power control parameter (e.g., that indicates an intended receive power at the BS), PL(q) is the path-loss measured by DL reference signals (RSs) where q is the path-loss index (useful for beam-based power control), M_{RB} is the number of resource blocks (RBs) of the PUCCH transmission (i.e., bandwidth), Δ_{F} is an RRC configured parameter specific for a PUCCH format, Δ_{TF} is a delta power based on a spectral efficiency of a PUCCH, and g(ι) is a closed-loop power control.

Parameter Δ_{TF} may be calculated based on a total number of bits in the UCI. When the total number of bits in the UCI is greater than eleven, Δ_{TF} may be determined by:

Δ_{TF}=10log₁₀((2^{BPRE·K}^{₂}−1))

where K₂=2.4. When the total number of bits in the UCI is less than or equal to eleven, Δ_{TF} may be determined by:

Δ_{TF}=10log₁₀(BPRE·K₁)

As shown, Δ_{TF} may be a function of Bits Per Resource Element (BPRE). BPRE generally represents the effective coding rate (also referred to as the spectral efficiency) of the PUCCH determined by the following equation:

$$B P R E = \frac{♯ UCI including CRC bits}{{N}_{R E}}$$

where N_{RE} denotes the number of resource elements (REs) used to transmit the number of UCI (and cyclic redundancy check (CRC) bits).

Accordingly, the transmit power of a PUCCH may depend on the effective code rate of transmission, as described by the power control equation above. However, because UCIs assigned different priorities may be separately encoded, different rates may be associated with each UCI.

Aspects described herein provide techniques for enhanced power control for HP and LP UL transmission multiplexing, and more particularly to, techniques for the computation of transmit power when a first UCI, assigned a first priority (e.g., LP), and a second UCI, assigned a second priority (e.g., HP), are multiplexed in a PUCCH transmission. In some aspects, the first UCI and the second UCI may be separately encoded.

### Example Methods of Enhanced Power Control for High Priority (HP) and Low Priority (LP) Uplink (UL) Transmission Multiplexing

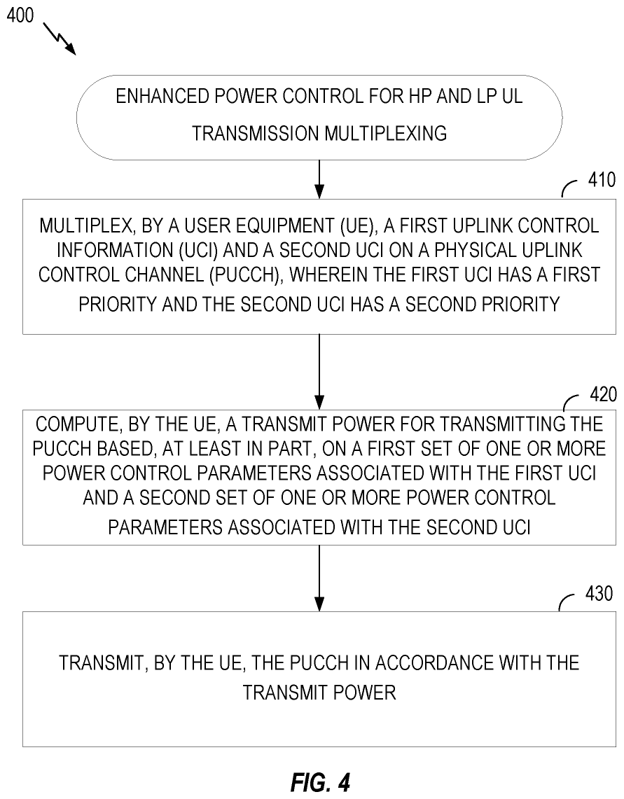

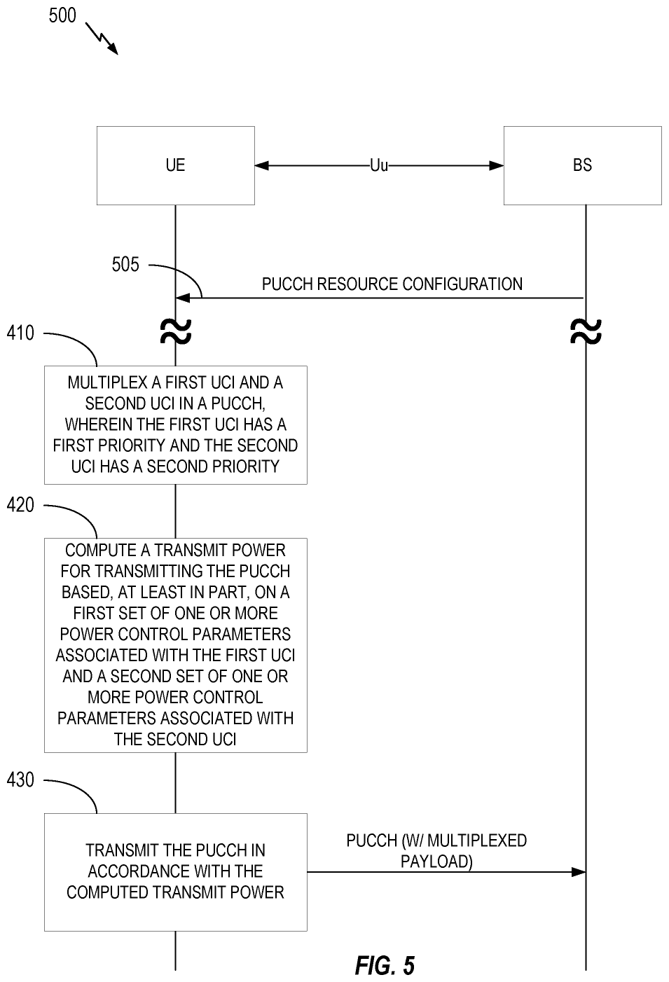

FIG. 4 is a flow diagram depicting an example method 400 for enhanced power control for multiplexing uplink (UL) transmissions of different priority, such as HP and LP uplink control information (UCI). Method 400 may be understood with reference to data flow 500 of FIG. 5 which depicts an example data flow between a user equipment (UE) and a base station (BS) for power control when transmitting a PUCCH with a multiplexed payload.

In some cases, a UE (e.g., UE 104 in wireless communication network 100 of FIG. 1), or a portion thereof, may perform, or be configured, operable, or adapted to perform, operations of method 400. In some cases, operations of method 400 may be implemented as software components (e.g., power control component 281 of FIG. 2) that are executed and run on one or more processors (e.g., controller/processor 280 of FIG. 2). Signals involved in the operations may be transmitted or received by the UE by one or more antennas (e.g., antennas 252 of FIG. 2), or via a bus interface of one or more processors (e.g., the controller/processor 280) obtaining and/or outputting the signals.

FIG. 4 depicts one example of a method consistent with the disclosure herein, but other examples are possible, which may include additional or alternative steps, or which omit certain steps. The various examples discussed with respect to FIG. 4 are illustrative and not meant to limit the scope of method 400.

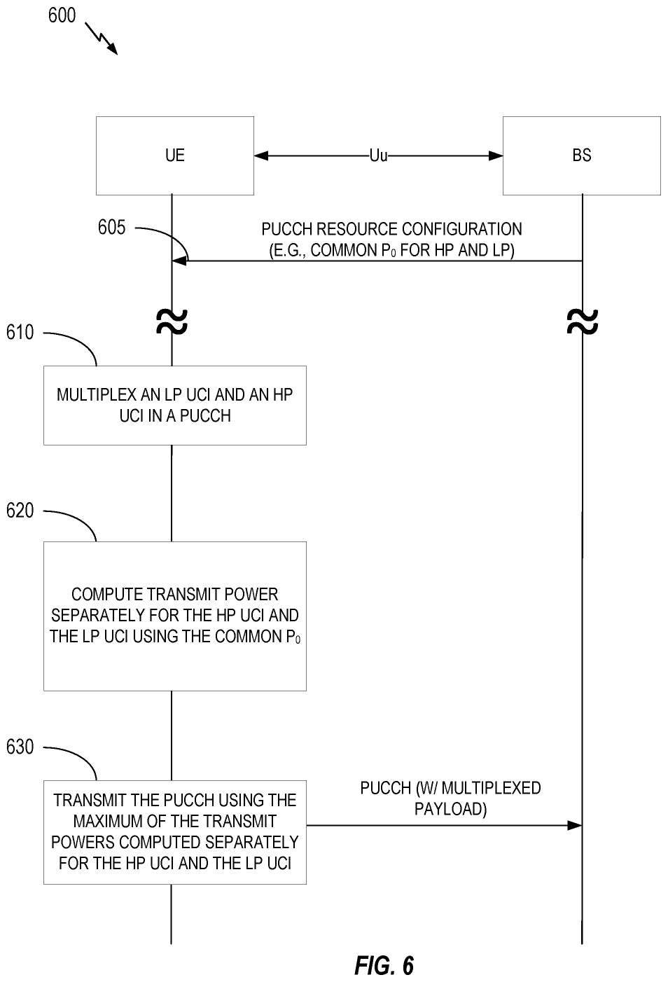

While method 400 may be understood with reference to data flow 500 of FIG. 5, further details for power control when transmitting a PUCCH with a multiplexed payload may be depicted in data flows 600, 700, and 800 of FIGS. 6, 7, and 8, respectively.

Method 400 begins at step 410 with a UE multiplexing a first uplink control information (UCI) and a second UCI in a physical uplink control channel (PUCCH), wherein the first UCI has a first priority and the second UCI has a second priority. As shown in FIG. 5, at step 410, the first UCI may be a LP UCI while the second UCI may be a HP UCI. In NR, an example of a HP UCI is a UCI associated with a priority index of 1, while an example of an LP UCI is a UCI associated with a priority index of 0. Accordingly, the first UCI may be an LP UCI associated with a priority index of 0 while the second UCI may be an HP UCI associated with a priority index of 1 (or vice-versa). At step 410, a UE (e.g., such as UE 104 illustrated in FIGS. 1 and 2) may multiplex the first UCI (e.g., LP UCI) and the second UCI (e.g., HP UCI) in a PUCCH.

In some cases, the first UCI and the second UCI may be separately encoded. In some cases, the first UCI and the second UCI may be jointly encoded.

Method 400 then proceeds to step 420 with the UE computing a transmit power based on a first set of one or more power control parameters associated with the first UCI and a second set of one or more power control parameters associated with the second UCI. In other words, as shown in FIG. 5, at step 420, the UE may compute a transmit power for transmitting the PUCCH based on a first set of one or more power control parameters associated with the LP UCI and a second set of one or more power control parameters associated with the HP UCI.

Further, as shown in the data flow 500 of FIG. 5, prior to step 410 and step 420, at step 505, UE may receive, from a BS (e.g., such as BS 102 illustrated in FIGS. 1 and 2), a PUCCH resource configuration (e.g., via a system information block (SIB) broadcast transmission). The PUCCH resource configuration may indicate the one or more power control parameters for the first set of power control parameters associated with the first UCI and one or more power control parameters for the second set of power control parameters associated with the second UCI. The PUCCH resource configuration may include one or more open loop power control parameters (P₀) associated with a PUCCH resource.

Additionally, the UE, prior to steps 410 and 420, may receive one or more radio resource control (RRC) parameters, via RRC signaling, for use in computing the transmit power (e.g., Δ_{F} for a PUCCH format).

Method 400 then proceeds to step 430 with transmitting the PUCCH in accordance with the transmit power. Accordingly, as depicted in data flow 500 of FIG. 5, at 430, the UE transmits the PUCCH (with the multiplexed payload) to the BS.

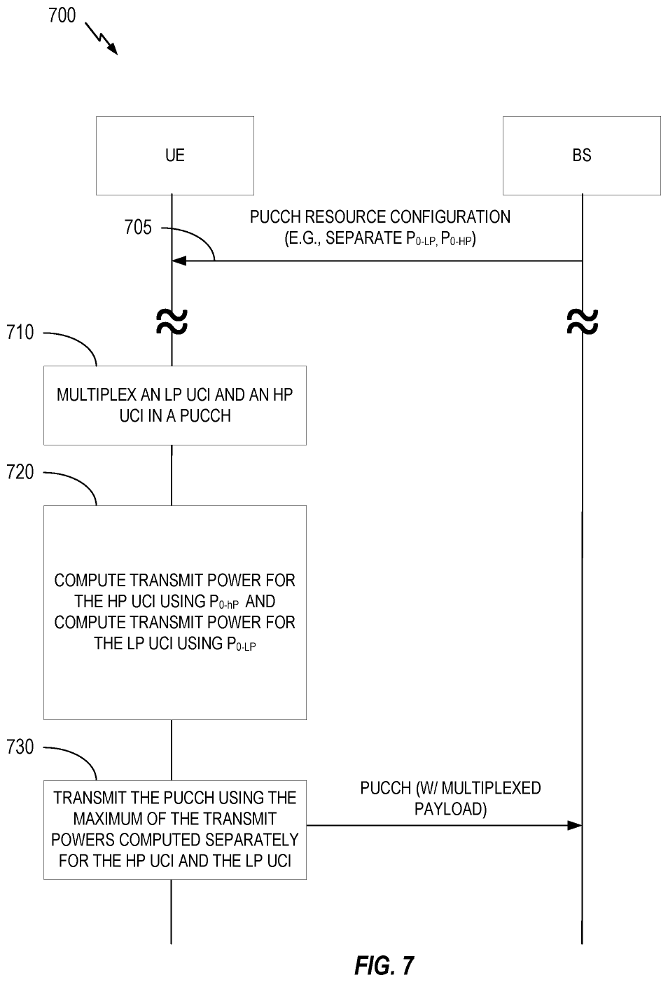

Various methods of computing the transmit power may be considered for power control of the multiplexed payload. In some cases, as illustrated in the data flows shown in FIGS. 6 and 7, computing the transmit power may include computing a first transmit power for the first UCI, computing a second transmit power for the second UCI, and selecting a maximum of the first and second transmit powers for transmitting the PUCCH.

As depicted in the data flow 600 of FIG. 6, in some cases, a UE may be configured (at step 605) with a common open loop power control parameter (common P₀). The common open loop power control parameter (common P₀) may be associated with a PUCCH resource used to transmit the PUCCH. At step 610, the UE may multiplex an LP UCI and an HP UCI. At step 620, the UE may compute transmit power separately for the LP UCI (P_{LP}) and the HP UCI (P_{HP}) using the common P₀. Further, computation of the LP UCI (P_{LP}) and the HP UCI (P_{HP}) may be computed using a first effective coding rate (e.g., spectral efficiency or Bits Per Resource Element (BPRE)) associated with the LP UCI and a second effective coding rate associated with the HP UCI, respectively. At step 630, the UE may then transmit the PUCCH with the multiplexed HP UCI and LP UCI using the maximum of the transmit powers separately calculated using the common P₀, and, in some cases, different effective coding rates associated with each of the LP and HP UCI (e.g., P_{PUCCH}=max{P_{LP}, P_{HP}}).

Alternatively, as depicted in data flow 700 of FIG. 7, in some cases, a UE may be configured (at step 705) with separate open loop power control parameters (P_{0-LP} and P_{0-HP}) rather than a common P₀. At step 710, the UE may multiplex an LP UCI and an HP UCI. At step 720, the UE may then compute transmit power for the HP UCI (P_{HP}) using P_{0-HP} and an effective coding rate associated with the HP UCI. The UE may compute transmit power for the LP UCI (P_{LP}) using P_{0-LP} and an effective coding rate associated with the LP UCI. At step 730, the UE may then transmit the PUCCH with the multiplexed HP UCI and LP UCI using the maximum of the transmit powers separately calculated using the separate open loop power control parameters (P_{0-LP} and P_{0-HP}).

The separate open loop power control parameters may be associated with (configured for) a PUCCH resource used to transmit the PUCCH. As an alternative, the open loop power control parameter (P_{0-HP}) used to calculate the transmit power for the HP UCI (P_{HP}) may be associated with a PUCCH resource that was scheduled to transmit the HP UCI, while the open loop power control parameter (P_{0-LP}) used to calculate the transmit power for the LP UCI (P_{LP}) may be associated with a PUCCH resource that was scheduled to transmit the LP UCI.

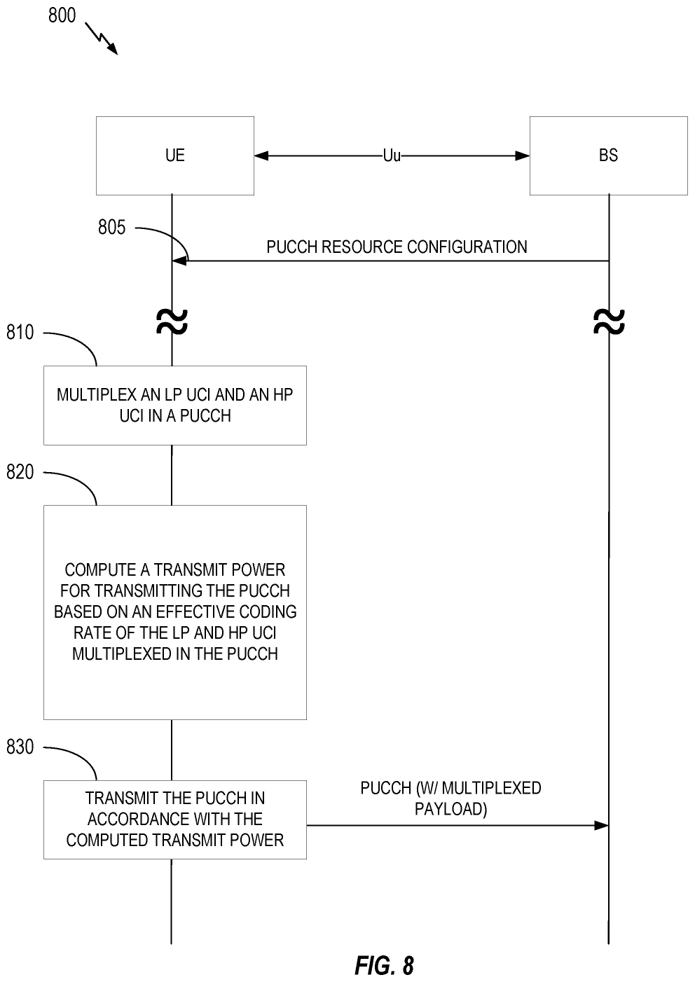

FIG. 8 depicts an example data flow 800 between a UE and a BS for power control, when transmitting a PUCCH with a multiplexed payload, based on an effective coding rate based on a total number of UCI bits. In particular, as depicted in data flow 800 of FIG. 8, a UE (e.g., such as UE 104 illustrated in FIGS. 1 and 2), may be configured (at step 805) with a PUCCH resource configuration by a BS (e.g., such as BS 102 illustrated in FIGS. 1 and 2). At step 810, the UE may multiplex an LP UCI and an HP UCI, and at step 820, compute a transmit power using an effective coding rate based on the total number of HP and LP UCI bits in the multiplexed payload. At step 830, the UE may transmit the PUCCH with the multiplexed HP UCI and LP UCI using the transmit power calculated using the effective coding rate based on the total number of HP and LP UCI bits.

For example, the transmit power for the multiplexed HP and LP UCI on the PUCCH may be determined based on the NR 3GPP Release 16 power control equation, as described above, with modifications to parameter Δ_{TF} (e.g., a delta power based on a spectral efficiency to account for the combined HP and LP UCI payload of the multiplexed PUCCH).

Parameter Δ_{TF} may be calculated based on a total number of bits in the HP and LP UCI. When the total number of bits in the UCI (inlcluding both LP and HP UCI) is greater than eleven, Δ_{TF} may be determined by:

Δ_{TF}=10log₁₀((2^{BPRE·K}^{₂}−1))

where K₂=2.4. When the total number of bits in the UCI (including both LP and HP UCI) is less than or equal to eleven, Δ_{TF} may be determined by:

Δ_{TF}=10log₁₀(BPRE·K₁)

As shown, Δ_{TF} may be a function of Bits Per Resource Element (BPRE). BPRE may stand for the effective coding rate (also referred to as the spectral efficiency) of the PUCCH determined by:

$$B P R E = \frac{{O}_{L P , UCI} + {O}_{L P , C R C} + {O}_{H P , UCI} + {O}_{H P , C R C}}{{N}_{R E}}$$

where O_{LP,UCI} denotes a number of bits in the LP UCI, O_{LP,CRC} denotes a number of cyclic redundancy check (CRC) bits for the LP UCI, 0_{HP,UCI} denotes a number of bits in the HP UCI, 0_{HP,CRC} denotes a number of CRC bits for the HP UCI, and N_{RE} denotes the number of resource elements (REs) used to transmit the UCI.

In some cases, the LP UCI may have a higher coding rate than HP UCI. Thus, the computed transmit power for transmitting the PUCCH with the multiplexed payload may be larger than the power required for the HP UCI (if calculated based only on the HP UCI and CRC bits).

FIGS. 4-8 depict examples of a method consistent with the disclosure herein, but other methods may be possible for power control when transmitting a PUCCH with a multiplexed payload.

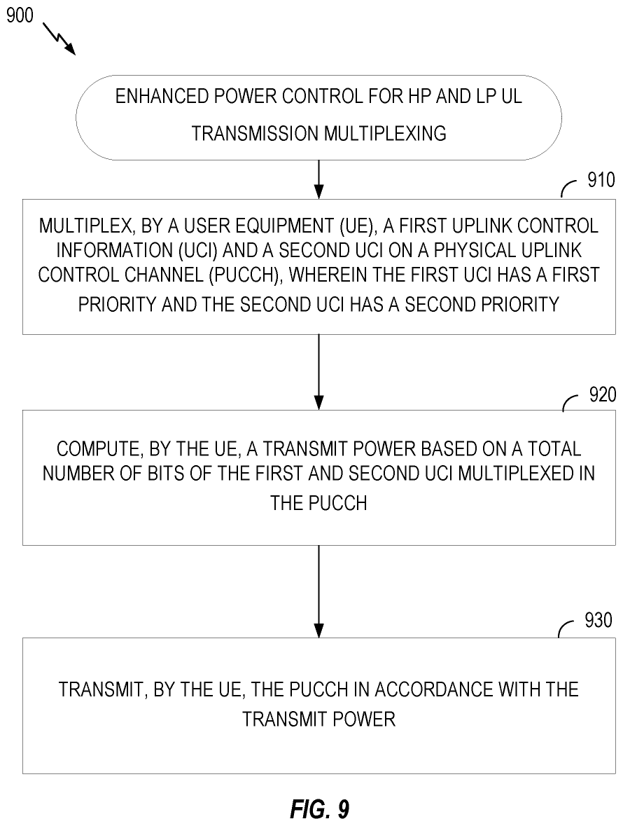

FIG. 9 is a flow diagram depicting another example method 900 for enhanced power control for HP and LP UL transmission multiplexing.

In some cases, a UE (e.g., UE 104 in wireless communication network 100 of FIG. 1), or a portion thereof, may perform, or be configured, operable, or adapted to perform, operations of method 900. In some cases, operations of method 900 may be implemented as software components (e.g., power control component 281 of FIG. 2) that are executed and run on one or more processors (e.g., controller/processor 280 of FIG. 2). Signals involved in the operations may be transmitted or received by the UE by one or more antennas (e.g., antennas 252 of FIG. 2), or via a bus interface of one or more processors (e.g., the controller/processor 280) obtaining and/or outputting the signals.

FIG. 9 depicts one example of a method consistent with the disclosure herein, but other examples are possible, which may include additional or alternative steps, or which omit certain steps.

Method 900 begins at step 910 with a UE multiplexing a first UCI and a second UCI on a PUCCH, wherein the first UCI has a first priority and the second UCI has a second priority.

In some cases, the first priority comprises a higher priority than the second priority. Accordingly, the first UCI may be a HP UCI while the second UCI may be a LP UCI.

In some cases, the first UCI and the second UCI may be separately encoded. In some cases, the first UCI and the second UCI may be jointly encoded.

Method 900 then proceeds to step 920 with the UE computing a transmit power based on a total number of bits of the first and second UCI multiplexed in the PUCCH. In certain aspects, computing the transmit power includes computing the transmit power based on an effective coding rate of the first and second UCI multiplexed on the PUCCH. The effective coding rate may be calculated based on at least one of: a number of bits in the first UCI, a number of bits in the second UCI or a number of resource elements (N_{RE}) used to transmit the PUCCH.

In certain aspects, the transmit power is computed using a common open loop power control parameter common to both the first UCI and the second UCI (P₀). More specifically, the transmit power may be computed using the P₀ and an effective coding rate (e.g., BPRE) associated with both the HP and LP UCI. In some examples, the open loop power control parameter (e.g., P₀) may be associated with a PUCCH resource used to transmit the PUCCH (with the multiplexed payload).

Method 900 then proceeds to step 930 with the UE transmitting the PUCCH in accordance with the transmit power.

In certain aspects, a format of the PUCCH comprises a PUCCH format 1.

In certain aspects, method 900 further includes a step for comparing the total number of bits to a threshold. In certain aspects, the transmit power is computed based on the comparison.

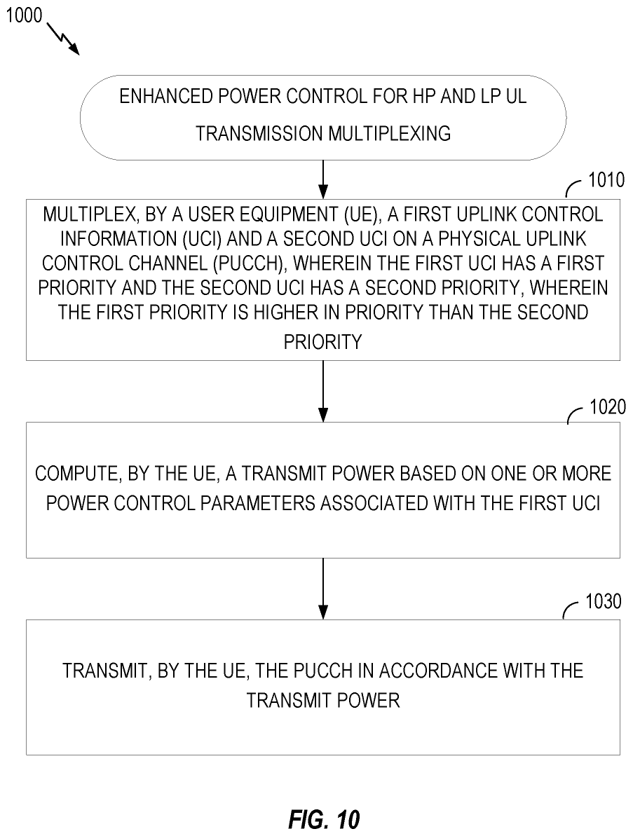

FIG. 10 is a flow diagram depicting another example method 1000 for enhanced power control for HP and LP UL transmission multiplexing.

In some cases, a UE (e.g., UE 104 in wireless communication network 100 of FIG. 1), or a portion thereof, may perform, or be configured, operable, or adapted to perform, operations of method 1000. In some cases, operations of method 1000 may be implemented as software components (e.g., power control component 281 of FIG. 2) that are executed and run on one or more processors (e.g., controller/processor 280 of FIG. 2). Signals involved in the operations may be transmitted or received by the UE by one or more antennas (e.g., antennas 252 of FIG. 2), or via a bus interface of one or more processors (e.g., the controller/processor 280) obtaining and/or outputting the signals.

FIG. 10 depicts one example of a method 1000 consistent with the disclosure herein, but other examples are possible, which may include additional or alternative steps, or which omit certain steps.

Method 1000 begins at step 1010 with a UE multiplexing a first UCI and a second UCI on a PUCCH, wherein the first UCI has a first priority and the second UCI has a second priority, wherein the first priority is higher in priority than the second priority. Accordingly, the first UCI may be a HP UCI while the second UCI may be a LP UCI.

In some cases, the first UCI and the second UCI may be separately encoded.

Method 1000 then proceeds to step 1020 with the UE computing a transmit power based on one or more power control parameters associated with the first UCI. In other words, at step 1020, computing a transmit power may be based on one or more power control parameters associated with the HP UCI. Thus, the transmit power may be determined based on the transmit power calculated for HP UCI only, based on the 3GPP Release 16 power control equation, as described above.

As noted above, the power control parameters may include an open loop power control parameter (P₀)(e.g., P_{0-HP}) used to compute the transmit power. More specifically, the transmit power may be computed using the P_{0-HP} and an effective coding rate (e.g., BPRE) associated with the HP UCI. In some examples, the open loop power control parameter (e.g., P_{0-HP}) may be associated with a PUCCH resource used to transmit the PUCCH (with the multiplexed payload). In some examples, the open loop power control parameter (e.g., P_{0-HP}) may be associated with a PUCCH resource scheduled for the first UCI (e.g., HP UCI).

In certain aspects, computing the transmit power for transmitting the PUCCH is further based on a number of bits in the first UCI and a number of CRC bits for the first UCI.

In certain aspects, computing the transmit power for transmitting the PUCCH is further based on an effective coding rate of the first UCI. In some cases, the effective coding rate is based on a number of bits in the first UCI, a number of CRC bits for the first UCI, and a number of resource elements (N_{RE}) used to transmit the PUCCH.

In certain aspects, method 900 further includes a step for selecting a formula for computing the transmit power based on a number of a number of bits in the first UCI and a number of CRC bits for the first UCI. For example, as described above, a power control equation used to calculate the transmit power (P_{PUCCH}) from a UE for a PUCCH is

P_{PUCCH}=min{P_{c,max}, P₀(j)+PL(q)+10log₁₀(2^{μ}M_{RB})+Δ_{F}+Δ_{TF}+g(ι)}

where parameter Δ_{TF} may be calculated based on a total number of (HP and LP UCI) bits in the first UCI and a number of CRC bits for the first UCI. Based on the total number of bits, Δ_{TF} may be determined by:

Δ_{TF}=10log₁₀((2^{BPRE·K}^{₂}−1))

or Δ_{TF} may be determined by:

Δ_{TF}=10log₁₀(BPRE·K₁)

Method 1000 then proceeds to step 1030 with the UE transmitting the PUCCH in accordance with the transmit power.

In certain aspects, a format of the PUCCH comprises a first PUCCH format with a short format and greater than two bits for the first UCI multiplexed with the second UCI (e.g., PUCCH format 2). In certain aspects, a format of the PUCCH comprises a second PUCCH format with a long format, greater than two bits for the first UCI multiplexed with the second UCI, and without multi-UE multiplexing (e.g., PUCCH format 3). In certain aspects, a format of the PUCCH comprises a third PUCCH format with a long format, greater than two bits for the first UCI multiplexed with the second UCI, and with multi-UE multiplexing (e.g., PUCCH format 4).

### Example Wireless Communication Devices

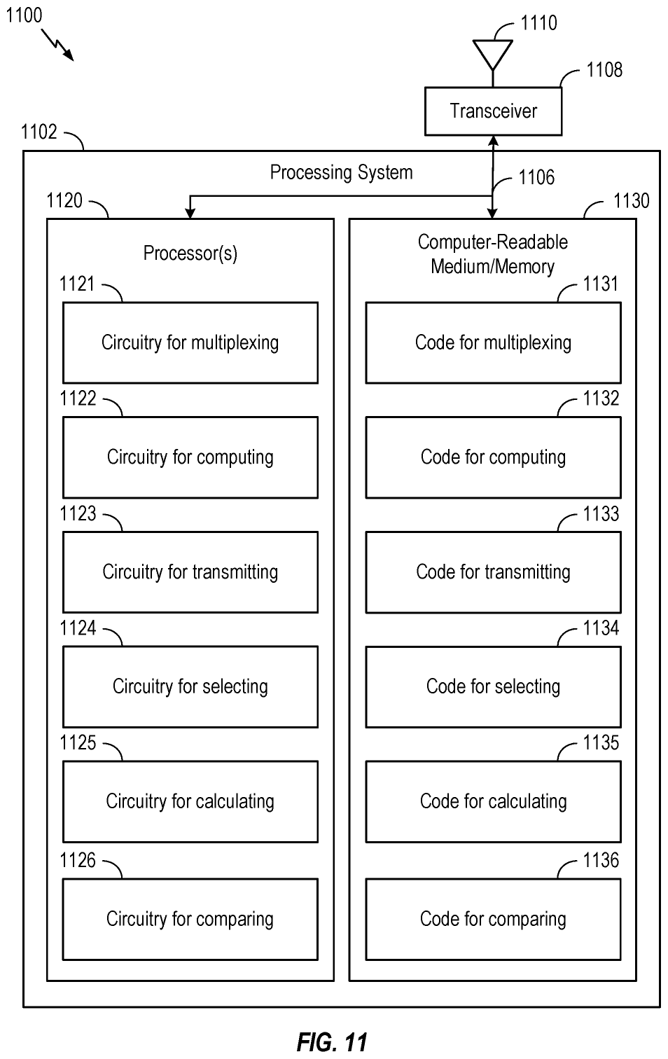

FIG. 11 depicts an example communications device 1100 that includes various components operable, configured, or adapted to perform operations for the techniques disclosed herein, such as the operations depicted and described with respect to FIGS. 4-10. In some examples, communication device 1100 may be a UE 104 as described, for example with respect to FIGS. 1 and 2.

Communications device 1100 includes a processing system 1102 coupled to a transceiver 1008 (e.g., a transmitter and/or a receiver). Transceiver 1108 is configured to transmit (or send) and receive signals for the communications device 1100 via an antenna 1110, such as the various signals as described herein. Processing system 1102 may be configured to perform processing functions for communications device 1100, including processing signals received and/or to be transmitted by communications device 1100.

Processing system 1102 includes a processor 1104 coupled to a computer-readable medium/memory 1112 via a bus 1106. In certain aspects, computer-readable medium/memory 1112 is configured to store instructions (e.g., computer-executable code) that when executed by processor 1104, cause processor 1104 to perform the operations illustrated in FIGS. 4-10, or other operations for enhanced power control for HP and LP UL transmission multiplexing.

In the depicted example, computer-readable medium/memory 1112 stores code 1131 for multiplexing (e.g., for multiplexing a first uplink control information (UCI) and a second UCI on a physical uplink control channel (PUCCH), wherein the first UCI has a first priority and the second UCI has a second priority and wherein, in some cases, the first priority is higher in priority than the second priority), code 1132 for computing (e.g., for computing a transmit power based on a first set of one or more power control parameters associated with the first UCI and a second set of one or more power control parameters associated with the second UCI, or for computing a transmit power based on total number of bits of the first and second UCI multiplexed in the PUCCH, or for computing a transmit power based on one or more power control parameters associated with the first UCI), code 1133 for transmitting (e.g., for transmitting the PUCCH in accordance with the transmit power), code 1134 for selecting (e.g., for selecting a maximum of the first and second transmit powers for transmitting the PUCCH), code 1135 for calculating (e.g., for calculating the effective coding rate), and code 1136 for comparing (e.g., for comparing the total number of bits to a threshold).

In the depicted example, processor 1120 has circuitry configured to implement the code stored in the computer-readable medium/memory 1130, including circuitry 1121 for multiplexing (e.g., for multiplexing a first UCI and a second UCI on a PUCCH, wherein the first UCI has a first priority and the second UCI has a second priority and wherein, in some cases, the first priority is higher in priority than the second priority), circuitry 1122 for computing (e.g., for computing a transmit power based on a first set of one or more power control parameters associated with the first UCI and a second set of one or more power control parameters associated with the second UCI, or for computing a transmit power based on a total number of bits of the first and second UCI multiplexed in the PUCCH, or for computing a transmit power based on one or more power control parameters associated with the first UCI), circuitry 1123 for transmitting (e.g., for transmitting the PUCCH in accordance with the transmit power), circuitry 1124 for selecting (e.g., for selecting a maximum of the first and second transmit powers for transmitting the PUCCH), circuitry 1125 for calculating (e.g., for calculating the effective coding rate), and circuitry 1126 for comparing (e.g., for comparing the total number of bits to a threshold).

Various components of communications device 1100 may provide means for performing the methods described herein, including with respect to FIGS. 4-10.

In some examples, means for multiplexing, means for computing, means for selecting, means for calculating, and means for comparing may include a processing system, which may include one or more processors, such as receive processor 258, transmit processor 264, TX MIMO processor 266, and/or controller/processor 280, including power control component 281, of the UE 104 illustrated in FIG. 2 and/or processing system 1102 of communication device 1100 in FIG. 11.

In some examples, means for transmitting or sending (or means for outputting for transmission) may include transceivers 254 and/or antenna(s) 252 of UE 104 illustrated in FIG. 2 and/or transceiver 1108 and antenna 1110 of communications device 1100 in FIG. 11.

In some examples, means for receiving (or means for obtaining) may include transceivers 254 and/or antenna(s) 252 of UE 104 illustrated in FIG. 2 and/or transceiver 1108 and antenna 1110 of communications device 1100 in FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

Notably, FIG. 11 is just a use example, and many other examples and configurations of communication device 1100 are possible.

### Example Clauses

Implementation examples are described in the following numbered clauses:

Clause 1: A method of wireless communication by a user equipment (UE), comprising: multiplexing a first uplink control information (UCI) and a second UCI in a physical uplink control channel (PUCCH), wherein the first UCI has a first priority and the second UCI has a second priority; computing a transmit power for transmitting the PUCCH based, at least in part, on a first set of one or more power control parameters associated with the first UCI and a second set of one or more power control parameters associated with the second UCI; and transmitting the PUCCH in accordance with the computed transmit power.

Clause 2: The method of Clause 1, wherein the first UCI and the second UCI are separately encoded.

Clause 3: The method of any one of Clauses 1-2, wherein computing the transmit power comprises: computing a first transmit power for the first UCI; computing a second transmit power for the second UCI; and selecting a maximum of the first and second transmit powers for transmitting the PUCCH.

Clause 4: The method of Clause 3, wherein: a first effective coding rate associated with the first UCI is used to compute the first transmit power; and a second effective coding rate associated with the second UCI is used to compute the second transmit power.

Clause 5: The method of any one of Clauses 3-4, wherein: the first set of power control parameters and the second set of power control parameters each include a common open loop power control parameter; and the first transmit power and second transmit power are both computed using the common open loop power control parameter.

Clause 6: The method of Clause 5, wherein the common open loop power control parameter is associated with a PUCCH resource used to transmit the PUCCH.

Clause 7: The method of any one of Clauses 3-6, wherein: the first set of power control parameters includes a first open loop power control parameter used to compute the first transmit power; the second set of power control parameters includes a second open loop power control parameter used to compute the second transmit power; and the first and second open loop power control parameters are different.

Clause 8: The method of Clause 7, wherein the first and second open loop power control parameters are both associated with a PUCCH resource used to transmit the PUCCH.

Clause 9: The method of any one of Clauses 7-8, wherein: the first open loop power control parameter is associated with a first PUCCH resource scheduled for the first UCI; and the second open loop power control parameter is associated with a second PUCCH resource scheduled for the second UCI.

Clause 10: The method of any one of Clauses 1-9, wherein the first UCI and the second UCI are jointly encoded.

Clause 11: The method of any one of Clauses 1-10, wherein computing the transmit power is further based, at least in part, on an effective coding rate of the first and second UCI multiplexed in the PUCCH.

Clause 12: The method of any one of Clauses 1-11, wherein computing the transmit power is further based a total number of bits of the first and second UCI multiplexed in the PUCCH.

Clause 13: The method of any one of Clauses 11-12, further comprising calculating the effective coding rate based on: a number of bits in the first UCI; a number of cyclic redundancy check (CRC) bits for the first UCI; a number of bits in the second UCI; a number of CRC bits for the second UCI; and a number of resource elements (N_{RE}) used to transmit the PUCCH.

Clause 14: A method of wireless communications, comprising: multiplexing a first uplink control information (UCI) and a second UCI in a physical uplink control channel (PUCCH), wherein the first UCI has a first priority and the second UCI has a second priority; computing a transmit power for transmitting the PUCCH based on a first set of one or more power control parameters associated with the first UCI; and transmitting the PUCCH in accordance with the computed transmit power.

Clause 15: The method of Clause 14, wherein: a first priority comprises a higher priority than the second priority.

Clause 16: The method of any one of Clauses 14-15, wherein computing the transmit power is further based, at least in part, on an effective coding rate of the first UCI.

Clause 17: The method of any one of Clauses 14-16, wherein: the first set of power control parameters includes an open loop power control parameter used to compute the transmit power.

Clause 18: The method of Clause 17, wherein the open loop power control parameter is associated with a PUCCH resource used to transmit the PUCCH.

Clause 19: The method of any one of Clauses 17-18, wherein the open loop power control parameter is associated with a PUCCH resource scheduled for the first UCI.

Clause 20: The method of any one of Clauses 14-19, wherein the first UCI and the second UCI are jointly encoded.

Clause 21: A method of wireless communication by a user equipment (UE), comprising: multiplexing a first uplink control information (UCI) and a second UCI on a physical uplink control channel (PUCCH), wherein the first UCI has a first priority and the second UCI has a second priority, wherein the first priority is higher in priority than the second priority; computing a transmit power based on one or more power control parameters associated with the first UCI; and transmitting the PUCCH in accordance with the transmit power.

Clause 22: The method of Clause 21, wherein computing the transmit power based on the one or more power control parameters associated with the first UCI comprises computing the transmit power based on the first priority being higher in priority than the second priority.

Clause 23: The method of any one of Clauses 21-22, computing the transmit power is further based on: a number of bits in the first UCI, and a number of cyclic redundancy check (CRC) bits for the first UCI.

Clause 24: The method of any one of Clauses 21-23, wherein computing the transmit power is further based on an effective coding rate of the first UCI.

Clause 25: The method of Clause 24, further comprising calculating the effective coding rate based on: a number of bits in the first UCI; a number of cyclic redundancy check (CRC) bits for the first UCI; and a number of resource elements (N_{RE}) used to transmit the first UCI on the PUCCH.

Clause 26: The method of any one of Clauses 21-25, wherein: the one or more power control parameters includes an open loop power control parameter used to compute the transmit power.

Clause 27: The method of Clause 26, wherein the open loop power control parameter is associated with a PUCCH resource used to transmit the PUCCH.

Clause 28: The method of any one of Clauses 26-27, wherein the open loop power control parameter is associated with a PUCCH resource scheduled for the first UCI.

Clause 29: The method of any one of Clauses 21-28, wherein the first UCI and the second UCI are separately encoded.

Clause 30: The method of any one of Clauses 21-29, wherein a format of the PUCCH comprises: a first format with a short format and greater than two bits for the first UCI multiplexed with the second UCI, a second format with a long format, greater than two bits for the first UCI multiplexed with the second UCI, and without multi-UE multiplexing, or a third format with the long format, greater than two bits for the first UCI multiplexed with the second UCI, and with the multi-UE multiplexing.

Clause 31: A method for wireless communication by a user equipment (UE), comprising: multiplexing a first uplink control information (UCI) and a second UCI on a physical uplink control channel (PUCCH), wherein the first UCI has a first priority and the second UCI has a second priority; computing a transmit power based on a total number of bits of the first and second UCI multiplexed in the PUCCH; and transmitting the PUCCH in accordance with the transmit power.

Clause 32: The method of Clause 31, wherein computing the transmit power comprises computing the transmit power based on an effective coding rate of the first and second UCI multiplexed on the PUCCH, wherein the effective coding rate is based on a total number of bits of the first and the second UCI, and wherein the effective coding rate is calculated based on at least one of: a number of bits in the first UCI; a number of bits in the second UCI; or a number of resource elements (N_{RE}) used to transmit the PUCCH.

Clause 33: The method of any one of Clauses 31-32, wherein the first UCI and the second UCI are separately encoded.

Clause 34: The method of any one of Clauses 31-33, wherein computing the transmit power comprises computing the transmit power using a common open loop power control parameter common to both the first UCI and the second UCI.

Clause 35: The method of Clause 34, wherein the common open loop power control parameter is associated with a PUCCH resource used to transmit the PUCCH.

Clause 36: The method of any one of Clauses 31-35, wherein a format of the PUCCH comprises a PUCCH format 1.

Clause 37: The method of any one of Clauses 31-36, further comprising: comparing the total number of bits to a threshold.

Clause 38: The method of Clause 37, wherein computing the transmit power comprises computing the transmit power based on the comparison.

Clause 39: An apparatus, comprising: a memory comprising computer-executable instructions; one or more processors configured to execute the computer-executable instructions and cause the processing system to perform a method in accordance with any one of Clauses 1-38.

Clause 40: An apparatus, comprising means for performing a method in accordance with any one of Clauses 1-38.

Clause 41: A non-transitory computer-readable medium comprising computer-executable instructions that, when executed by one or more processors of a processing system, cause the processing system to perform a method in accordance with any one of Clauses 1-38.

Clause 42: A computer program product embodied on a computer-readable storage medium comprising code for performing a method in accordance with any one of Clauses 1-38.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmW), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS or a home BS.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with core network 190 through second backhaul links 184. BSs 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 gigahertz (GHz) unlicensed frequency spectrum as used by the Wi-Fi AP 150. Small cell 102′, employing NR in an unlicensed frequency spectrum, may boost coverage to and/or increase capacity of the access network.

Some BSs, such as gNB 180 may operate in a traditional sub-6 GHz spectrum, in millimeter wave (mmW) frequencies, and/or near mmW frequencies in communication with the UE 104. When the gNB 180 operates in mmW or near mmW frequencies, the gNB 180 may be referred to as an mmW BS.

The communication links 120 between BSs 102 and, for example, UEs 104, may be through one or more carriers. For example, BSs 102 and UEs 104 may use spectrum up to Y megahertz (MHz) (e.g., 5, 10, 15, 20, 100, 400, and other MHz) bandwidth per carrier allocated in a carrier aggregation of up to a total of Yx MHz (x component carriers (CCs)) used for transmission in each direction. The carriers may or may not be adjacent to each other. Allocation of carriers may be asymmetric with respect to the downlink (DL) and the uplink (UL) (e.g., more or fewer carriers may be allocated for DL than for UL). The CCs may include a primary CC and one or more secondary CC. A primary CC may be referred to as a primary cell (PCell) and a secondary CC may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to BSs 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides quality of service (QoS) flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., in wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM)) to obtain an output sample stream. Each modulator may further process (e.g., convert to analog, amplify, filter, and upconvert) the output sample stream to obtain a DL signal. DL signals from the modulators in transceivers 232a-232t may be transmitted via the antennas 234a-234t, respectively.

At UE 104, antennas 252a-252r may receive the DL signals from BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the UL, at UE 104, transmit processor 264 may receive and process data (e.g., for the PUSCH) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single carrier-frequency division multiplexing (SC-FDM)), and transmitted to BS 102.

At BS 102, the UL signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the DL and/or UL.

Antennas 252, processors 266, 258, 264, and/or controller/processor 280 of UE 104 and/or antennas 234, processors 220, 230, 238, and/or controller/processor 240 of BS 102 may be used to perform the various techniques and methods described herein.

For example, as shown in FIG. 2, controller/processor 240 of BS 102 has a power control component 241 that may be configured to configure one or more sets of power control parameters between BSs 102 and UEs 104, according to aspects described herein. Similarly, as shown in FIG. 2, controller/processor 280 of UE 104 has a power control component 281 that may be configured to compute the transmit power for transmitting a PUCCH with a multiplexed payload, according to aspects described herein. Although shown at the controller/processor, other components of UE 104 may be used to perform the operations described herein.

5G may utilize OFDM with a cyclic prefix (CP) on the UL and DL. 5G may also support half-duplex operation using time division duplexing (TDD). OFDM and SC-FDM partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be TDD, in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 milliseconds (ms)) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be CP-OFDM symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The SCS and symbol length/duration are a function of the numerology. The SCS may be equal to 2^{μ}×15 kHz, where μ is the numerology 0 to 5. As such, the numerology μ=0 has an SCS of 15 kHz and the numerology μ=5 has an SCS of 480 kHz. The symbol length/duration is inversely related to the SCS. FIGS. 3A-3D provide an example of slot configuration 0 with 14 symbols per slot and numerology μ=2 with 4 slots per subframe. The slot duration is 0.25 ms, the SCS is 60 kHz, and the symbol duration is approximately 16.67 μs.

A resource grid may be used to represent the frame structure. Each time slot includes an RB (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RSs) for a UE (e.g., UE 104 of FIGS. 1 and 2). The RSs may include demodulation RSs (DM-RSs) (indicated as Rx for one particular configuration, where 100x is the port number, but other DM-RS configurations are possible) and channel state information reference signals (CSI-RSs) for channel estimation at the UE. The RSs may also include beam measurement RSs (BRSs), beam refinement RSs (BRRSs), and phase tracking RSs (PT-RSs).

FIG. 3B illustrates an example of various DL channels within a subframe of a frame. The PDCCH carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the BS. The UE may transmit DM-RS for the PUCCH and DM-RS for the PUSCH. The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRSs). The SRSs may be transmitted in the last symbol of a subframe. The SRSs may have a comb structure, and a UE may transmit SRSs on one of the combs. The SRSs may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries UCI, such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of enhanced power control for high priority (HP) and low priority (LP) uplink (UL) transmission multiplexing. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used in this disclosure outside of the claims, the phrase “based on” is inclusive of all interpretations and shall not be limited to any single interpretation unless specifically recited or indicated as such. For example, the phrase “based on X” (where “X” may be information, a condition, a factor, or the like) may be interpreted as: “based at least on X,” “based in part on X,” “based at least in part on X,” “based only on X,” or “based solely on X.” Accordingly, as disclosed herein, “based on X” may, in one aspect, refer to “based at least on X.” In another aspect, “based on X” may refer to “based in part on X.” In another aspect, “based on X” may refer to “based at least in part on X.” In another aspect, “based on X” may refer to “based only on X.” In another aspect, “based on X” may refer to “based solely on X.” In another aspect, “based on X” may refer to any combination of interpretations in the alternative. As used in the claims, the phrase “based on X” shall be interpreted as “based at least on X” unless specifically recited differently.

Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor).

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 4-10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, and others), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated herein. Various modifications, changes and variations may be made in the arrangement, operation, and details of the methods and apparatus described herein.

1. An apparatus configured for wireless communication, comprising:
a memory; and
one or more processors coupled to the memory, wherein the one or more processors are configured to:
multiplex a first uplink control information (UCI) and a second UCI on a physical uplink control channel (PUCCH), wherein the first UCI has a first priority and the second UCI has a second priority, wherein the first priority is higher in priority than the second priority;
compute a transmit power based on one or more power control parameters associated with the first UCI; and
transmit the PUCCH in accordance with the transmit power.

2. The apparatus of claim 1, wherein the one or more processors are configured to compute the transmit power based on the one or more power control parameters associated with the first UCI, based on the first priority being higher in priority than the second priority.

3. The apparatus of claim 1, wherein the one or more processors are configured to compute the transmit power further based on:
a number of bits in the first UCI, and
a number of cyclic redundancy check (CRC) bits for the first UCI.

4. The apparatus of claim 1, wherein the one or more processors are configured to compute the transmit power further based on an effective coding rate of the first UCI.

5. The apparatus of claim 4, wherein the one or more processors are further configured to calculate the effective coding rate based on:
a number of bits in the first UCI;
a number of cyclic redundancy check (CRC) bits for the first UCI; and
a number of resource elements (N_{RE}) used to transmit the first UCI on the PUCCH.

6. The apparatus of claim 1, wherein:
the one or more power control parameters includes an open loop power control parameter used to compute the transmit power.

7. The apparatus of claim 6, wherein the open loop power control parameter is associated with a PUCCH resource used to transmit the PUCCH.

8. The apparatus of claim 6, wherein the open loop power control parameter is associated with a PUCCH resource scheduled for the first UCI.

9. The apparatus of claim 1, wherein the first UCI and the second UCI are separately encoded.

10. The apparatus of claim 1, wherein a format of the PUCCH comprises:
a first format with a short format and greater than two bits for the first UCI multiplexed with the second UCI,
a second format with a long format, greater than two bits for the first UCI multiplexed with the second UCI, and without multi-UE multiplexing, or
a third format with the long format, greater than two bits for the first UCI multiplexed with the second UCI, and with the multi-UE multiplexing.

11. An apparatus configured for wireless communication, comprising:
a memory; and
one or more processors coupled to the memory, wherein the one or more processors are configured to:
multiplex a first uplink control information (UCI) and a second UCI on a physical uplink control channel (PUCCH), wherein the first UCI has a first priority and the second UCI has a second priority;
compute a transmit power based on a total number of bits of the first and second UCI multiplexed in the PUCCH; and
transmit the PUCCH in accordance with the transmit power.

12. The apparatus of claim 11, wherein to compute the transmit power, the one or more processors are configured to compute the transmit power based on an effective coding rate of the first and second UCI multiplexed on the PUCCH, wherein the effective coding rate is based on a total number of bits of the first and the second UCI, and wherein the effective coding rate is calculated based on at least one of:
a number of bits in the first UCI;
a number of bits in the second UCI; or a number of resource elements (N_{RE}) used to transmit the PUCCH.

13. The apparatus of claim 11, wherein the first UCI and the second UCI are separately encoded.

14. The apparatus of claim 11, wherein the one or more processors are configured compute the transmit power using a common open loop power control parameter common to both the first UCI and the second UCI.

15. The apparatus of claim 14, wherein the common open loop power control parameter is associated with a PUCCH resource used to transmit the PUCCH.

16. The apparatus of claim 11, wherein a format of the PUCCH comprises a PUCCH format 1.

17. The apparatus of claim 11, wherein the one or more processors are further configured to compare the total number of bits to a threshold.

18. The apparatus of claim 17, wherein the one or more processors are configured to compute the transmit power based on the comparison.

19. A method of wireless communications by a user equipment (UE), comprising:
multiplexing a first uplink control information (UCI) and a second UCI on a physical uplink control channel (PUCCH), wherein the first UCI has a first priority and the second UCI has a second priority, wherein the first priority is higher in priority than the second priority;
computing a transmit power based on one or more power control parameters associated with the first UCI; and
transmitting the PUCCH in accordance with the transmit power.

20. The method of claim 19, wherein computing the transmit power based on the one or more power control parameters associated with the first UCI comprises computing the transmit power based on the first priority being higher in priority than the second priority.

21. The method of claim 19, wherein computing the transmit power is further based on:
a number of bits in the first UCI, and
a number of cyclic redundancy check (CRC) bits for the first UCI.

22. The method of claim 19, wherein computing the transmit power is further based on an effective coding rate of the first UCI.

23. The method of claim 22, further comprising calculating the effective coding rate based on:
a number of bits in the first UCI;
a number of cyclic redundancy check (CRC) bits for the first UCI; and
a number of resource elements (N_{RE}) used to transmit the first UCI on the PUCCH.

24. The method of claim 19, wherein:
the one or more power control parameters includes an open loop power control parameter used to compute the transmit power.

25. The method of claim 24, wherein the open loop power control parameter is associated with a PUCCH resource used to transmit the PUCCH.

26. The method of claim 24, wherein the open loop power control parameter is associated with a PUCCH resource scheduled for the first UCI.

27. The method of claim 19, wherein the first UCI and the second UCI are separately encoded.

28. The method of claim 19, wherein a format of the PUCCH comprises:
a first format with a short format and greater than two bits for the first UCI multiplexed with the second UCI,
a second format with a long format, greater than two bits for the first UCI multiplexed with the second UCI, and without multi-UE multiplexing, or
a third PUCCH format with the long format, greater than two bits for the first UCI multiplexed with the second UCI, and with the multi-UE multiplexing.

29. A method of wireless communication by a user equipment (UE), comprising:
multiplexing a first uplink control information (UCI) and a second UCI on a physical uplink control channel (PUCCH), wherein the first UCI has a first priority and the second UCI has a second priority;
computing a transmit power based on a total number of bits of the first and second UCI multiplexed in the PUCCH; and
transmitting the PUCCH in accordance with the transmit power.

30. The method of claim 29, further comprising:
comparing the total number of bits to a threshold.
